(19) United States
(12) Patent Application Publication
(10) Pub. No.: US 2017/0337652 A1
(43) Pub. Date: Nov. 23, 2017

(54) LOCALLY BROADCASTED TOKEN TO CAUSE IMAGE MASKING OF USER LIKENESS

(71) Applicant: PAYPAL, INC., San Jose, CA (US)

(72) Inventor: Pankaj Sarin, New Delhi (IN)

(21) Appl. No.: 15/162,486

(22) Filed: May 23, 2016

(51) Int. Cl. G06Q 50/26; G06K 9/00; G06Q 20/40; H04N 1/44

(52) U.S. Cl. CPC G06Q 50/265; H04N 1/4493; G06K 9/00295; G06Q 20/40

(57) ABSTRACT

There are provided systems and methods for a locally broadcasted token to cause image masking of user likeness. A first user may establish a masking request for images taken by other users to conceal the first user's image or likeness in those images. The masking request may correspond to a token, such as a data package, that includes a request to mask the first user in the images, an image of the first user used to perform facial recognition to identify the user in the images, and a masking image to mask the user in the images. Additionally, the token may include an identifier used to contact the first user or a payment option to pay the first user to unmask the first user in the images. The token may be broadcast over an area around the first user to mask the first user in images on receiving devices.

### TECHNICAL FIELD

The present application generally relates to image masking for privacy concerns, and more specifically to a locally broadcasted token to cause image masking of user likeness.

### BACKGROUND

People may attend public places where events may occur that a person (or user) may wish to remember or document. Users may capture images in these public areas in order to document the events, where the images may include the event, other users, and/or the user capturing the image. For example, it is common that a user may capture an image of a crowd at an event, or take an image of the user and the user's friends or family in a crowded area with other users. However, these other users, which may be captured in the images incidentally (or purposefully in some cases), may wish to be removed or masked from the images for privacy concerns. For example, with the increasing prevalence of social networking and media sharing, users may post images at events that may be damaging to workplace or personal reputations of other users. Additionally, as image recognition processing become more advanced, it is more common for image searches to return images of users that the user did not approve to have captured, and even may not have known the existence of such images. However, without being aware of the image being captured, or where the user capturing the image refuses to revise or delete the image, the user whose likeness is captured in the image without consent has no remedy to remove the user's likeness from the image.

### BRIEF DESCRIPTION OF THE DRAWINGS

FIG. 1 is a block diagram of a networked system suitable for implementing the processes described herein, according to an embodiment;

FIG. 2A is an exemplary setup screen for facial privacy through masking of a first user's likeness captured in images of others, according to an embodiment;

FIG. 2B is an exemplary image captured by a second user's communication device and including the likeness of the first user, according to an embodiment;

FIG. 2C is an exemplary image captured by a second user's communication device with the likeness of the first user hidden by a masking image, according to an embodiment;

FIG. 2D is an exemplary image captured by a second user's communication device and providing a payment option to remove the masking image hiding the likeness of the first user, according to an embodiment;

FIG. 3 is an exemplary system environment showing two communication devices interacting for use of a locally broadcasted token to cause image masking of user likeness, according to an embodiment;

FIG. 4 is a flowchart of an exemplary process for a locally broadcasted token to cause image masking of user likeness, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for a locally broadcasted token to cause image masking of user likeness. Systems suitable for practicing methods of the present disclosure are also provided.

Users may utilize various types of devices to capture images, including digital cameras, mobile smart phones, tablet computers, digital video recorders, gaming systems including mobile gaming systems, and other types electronic devices capable of capturing a digital image or video (e.g., digital media). Thus, although the terms “image,” “video,” or the like may be used throughout, it is understood that other forms of digital media may be interchanged for such terms as discussed herein. The image may include a location, items, environment, and other objects that may be captured. In this regard, the image may also include a representation or likeness of one or more users. For example, a user may capture the user's likeness (e.g., a “selfie”) or another user's likeness in an image when photographing or videotaping the user or the other users. Similarly, events, venues, locations, location administrators, and other entities may establish still image and/or video image cameras at or around a location to capture images, for example, crowds at an event used for marketing purposes. However, when capturing an image or video, the user may also capture other users. These other users may not wish to have their likeness or representation captured in an image due to privacy concerns, preferences, personal interests, employment reasons, security, etc. Thus, the other users may wish to have their likeness hidden or otherwise masked in images captured at or around the other users. In this regard, a user's likeness may correspond to a face, body, entire person, identifiable clothing, included accessories (e.g., purse, backpack, suitcase, briefcase, vehicle, etc.), associated users or companions (e.g., friends, relatives, partner, pets, etc.), or any combination of the aforementioned features. Thus, the user's likeness in an image may include some representation of the user that may be used to identify the user.

In order to mask a user's likeness in an image, a device application and/or a service provider server may be utilized to establish a locally broadcasted or transmitted token in an area at or nearby the user. A first user that wishes to mask the first user's likeness may establish preferences for image masking with the device or the service provider. For example, the device may correspond to the user's mobile device, such as a smart phone. The service provider may correspond to an online service provider that may provide services to a user, such as localized image masking to prevent the first user's likeness from appearing in images taken at a location, including a current location of the first user where the first user may be at risk of images being captured including the first user's likeness. The preferences may include a preference to prevent the first user's likeness from appearing in the image. The preferences may also be set to prevent the first user's likeness from only appearing in images of unknown other users or entities. For example, if the other user capturing the image is a friend of the first user, employer, or other known user/entity, the first user may establish a preference allowing the first user's likeness to appear in images captured by those users/entities. However, other unknown users/entities may be set in the preference to receive image masking if the first user's likeness appears in images captured by the unknown users/entities. The preferences for when to mask the user's likeness in images may also be location and/or time specific, such as requiring image masking of the first user's likeness at locations not known, previously visited, or accepted by the user, or requiring image masking during certain hours, for example, after a certain time and until another time. In other embodiments, further factors may also be utilized to determine when the first user's likeness should be masked in images, including at or nearby confidential meetings (e.g., based on a schedule of the user), activities of the user, user biometrics and/or detected state of body/mind, etc. For example, the first user's image may be masked if the user is detected to be exercising, eating or drinking, tired, inebriated, or another preset condition by the first user for image masking of the first user's likeness. The first user may therefore set the preferences for when masking of the first user's likeness in an image should be activated based on one or more of the aforementioned conditions, which may also be context specific (e.g., only enable image masking of the first user's likeness when the first user is both located in a foreign location and after a certain time).

The preferences that the first user may establish regarding image masking of the likeness of the first user may also include a masking image that should appear in place of the first user's likeness in an image. For example, the masking image may be selected from a plurality of available masking images, which may be generally provided to and/or selected by the user. Thus, the masking image may correspond to a cartoon character (e.g., Mickey Mouse®), an emoji or other small graphical image, an image captured by the user, or other such image that may obscure, hide, or otherwise conceal the likeness of the first user in the image. The application and/or service provider may process any user selected image to ensure that the user selected image by the first user complies with terms of service and other requirements, for example, to prevent selection and/or submission of obscene images or images that may violate laws, including trademark or copyright laws. In other embodiments, selection of the masking image may correspond to an editing or redaction tool that manipulates the image, such as black-out markings, pixelating or blurring of the user's likeness, or other image or video editing tool.

In various embodiments, the first user may allow for the first user to be contacted by a second user capturing the image where the first user's likeness is masked. For example, the first user may allow the second user to remove the masking image that hides the first user's likeness if the first user approves of the image and/or use of their likeness in the image. Thus, an identifier used to contact the first user in order to remove the masking image from the image and allow the first user's likeness to be displayed in the image may be provided in the preferences by the first user. The identifier may correspond to a phone number, name, account name, messenger name, web address, email address, location, or other identifier that may be used to find and/or contact the first user by the second user. Additionally, the preferences may include an amount that may be paid to the first user for removal of the masking image from the image captured by the second user. For example, the first user may allow for the second user to pay a fee or premium to remove the masking of the first user's likeness in the image captured by the second user. In certain embodiments, such preferences may further include a communication medium and/or communication terms that allow the second user to contact the first user. For example, the first user may request that the image is forwarded to the first user from the second user, or that the second user personally display the image to the first user on the second user's device. The preferences and/or authorization to unmask the first user's likeness may also include terms of use of the image with the unmasked image of the first user's likeness. For example, the image may be retained on the second user's device. However, the first user's likeness may again be blurred if the image is communicated to other devices and/or uploaded to a sharing service (e.g., a social networking service). Such terms regarding usage may also be negotiated between the first user and the second user, which may include selection of the terms of usage from one or more menu options related to the application and/or service provider server providing the image masking. A form interface and/or options may be generated that allow the first and second user to negotiate cost and/or terms of use of the image having the first user's likeness unmasked may be provided in devices of the first and/or second user.

In order to provide image masking, the preferences may be utilized to generate a token. For example, the token may be generated when the preferences of the first user dictate that image masking of the first user's likeness is required (e.g., the token may be generated after the first user is detected to be located at a foreign location or after a certain time). In other embodiments, the token may previously be generated with the preferences of the first user and only cause image masking on other devices where the preferences of the first user require image masking (e.g., when the token detects it is on a foreign/unknown user's device, at a certain time, etc.). Moreover, in still further embodiments, the token may be generated and may only be transmitted to other devices when the preferences require image masking (e.g., the first user's device and/or the service provider may only transmit the token at certain locations, after a certain time, etc., required by the preferences, which may include selection of an activation or “on switch” to transmit the token by the first user through a device interface). In various embodiments, the token may be generated to include information entered by the first user in the user preferences. For example, the token may include at least the masking image selected by the first user, a user image of the first user used for image/video processing and/or facial/object recognition of the first user's likeness in images, and a masking request of the likeness of the first user in captured images. The masking request may include executable code instructing a device receiving the token to perform image and/or video analysis to determine if the first user's likeness is in the image using face, body, and/or object recognition of the first user or other likeness corresponding to the first user. Thus, the token may correspond to a data package having the masking image, the user image of the first user, and the masking request. In various embodiments, the token may further be generated with the identifier for the first user, which may be used to contact the first user, as well as any payment request by the first user requesting payment to unmask the first user's likeness in an image.

Once generated, the token may then be locally broadcasted over short range wireless communications by the device of the first user. For example, a mobile communication device of the first user, mobile beacon device of the first user or a service provider (e.g., a small device storing the token and utilizing short range wireless communications, such as a rechargeable key fob or other pocket sized beacon device), or other type of device, may utilize a short range communication protocol to continually or intermittently broadcast the token. The communication protocol may correspond to near field communications (NFC), Bluetooth, Bluetooth Low Energy (BLE), WiFi (e.g., IEEE 802.11x standard), LTE Direct, radio, infrared, or other short range communication protocol. The device of the first user may broadcast the token based on the preferences of the user, including always broadcasting or only broadcast when conditions meet the preference of the first user. In this regard, the device of the first user may utilize one or more features of the device (e.g., hardware and/or software) to detect present conditions and information, such as a time, location of the first user, biometric of the first user, etc. Such broadcast may correspond to an “always on” type request, where the broadcast is transmitted over the short range wireless communications to be receivable by other devices detecting the broadcast signal.

The first user may dictate how far or widely the token should be broadcast, for example, 10 yards, or at distance where the first user is not likely to be visible or recognizable in images. In various embodiments, the distance to broadcast the token may be determined based on the location of the first user, such as throughout an enclosed room but no farther (as it is unlikely or infeasible to capture an image of the first user from outside the enclosed room). In other embodiments, the distance may depend on the events occurring around the first user. For example, at a concert, venue taken images may be zoomed into a crowd, thus, the token may be broadcasted over a larger range. Thus, the device of the first user may make intelligent decisions of the proximity and/or area to broadcast the first token. In other embodiments, a server may transmit the token within an area associated with the first user, and may perform the above described features. For example, a service provider's server may transmit the token to local devices associated with the service provider to broadcast the token. In other embodiments, the service provider may utilize the location of the user to transmit the token to other devices detected at or nearby the location (within the determined proximity or area of the first user). In various embodiments, the communication channel used to transmit and/or broadcast the token may be based on the technology of receiving devices and what communication channels may be used to transmit the token to the receiving devices.

Thus, the token may be received by devices within an area around or nearby the location of the first user, such as a set proximity around the device or location of the first user. Other devices may receive the token and image masking may be effected based on the token. For example, a second user may utilize their device (e.g., mobile smart phone, tablet, digital camera, etc.) to capture an image (or other digital media) of the first user. The second user may have intended to capture other users in the image but the first user's likeness may be visible in the image, or may have intended to capture the image of the first user without the first user's consent. Thus, based on the token, the second user's device may execute the masking request within the token and utilize image processing, including facial or object recognition in images, with the user image of the first user in the token to determine whether the first user's likeness is present in the image captured by the second user. In various embodiments, the user image may instead correspond to code and/or image features (e.g., pixel arrangement, color, etc.) for the first user instead of an actual user image, which may be used for the image processing. If the first user's likeness is detected in the image, the second user's device may obscure, hide, or otherwise conceal the likeness of the first user in the image using the masking image provided in the token.

In various embodiments, the second user's device may further determine if the first user is a friend, contact, or other type of acquaintance of the second user for the second user's device. For example, the user image of the first user and/or the portion of the image having the first user's likeness may be scanned across a contact list, stored images, a social networking account, an online or stored photo book, uploaded videos, or other digital media associated with the second user to determine if the first user and the second user are acquaintances or otherwise identify together. If the first user and the second user are known to each other, then the device of the second user may not mask the likeness of the first user in the captured image (or other captured digital media), which may be based on preferences of the first user used with the token. In various embodiments, the identifier in the token may also be used to determine if the first user and the second user are acquaintances or associated with each other. For example, a phone number may be scanned across the contact list. However, if the first user and/or identifier are not found, the first user's likeness will be masked by placing the masking image over the likeness of the first user. In certain embodiments, the second user's device may further scan the detected facial images in an image across the second user's known contacts (e.g., stored images, contact list images, social networking accounts, etc.), and may mask all or further images where the second user's device does not recognize the facial images. Thus, options may be established by the second user to further mask other users in an image if the second user's device does not recognize the other users in images captured by the second user. Additionally, the request may only activate and mask the user's likeness as specific times, such as if posting to social network. Thus, the second user's device may display the image without image masking; however, apply image masking if the second user attempts to proliferate the image to other mediums.

Additionally, the second user may be provided with an option to remove the masking of the likeness of the first user in the image. For example, the identifier may be used to contact the first user by the second user, where the second user may request an authorization to remove the masking image from the image that conceals the first user's likeness. The option may populate as a menu option for the image, or may be selectable through selection of the masking image on a graphical user interface of the second user's device displaying the image. Thus, the other user may be provided with an option to contact the user and remove the masking image, for example, through the identifier of the user. As previously discussed, the first user and the second user may be required to agree to terms regarding use of the image, for example, limiting the second user from further transmitting or communicating the image with the unmasked likeness of the first user. Thus, the first user and the second user may utilize one or more device applications and/or a service provider to exchange negotiation terms. Additionally, the first user may require payment or provide a payment option to remove the masking image from the image. In this regard, the second user may select the remove the masking image by providing a payment to the first user. Thus, the second user's device may further include a payment application, which may be configured to send and receive payments to another party, such as another user and/or a merchant. The payment application may be associated with a payment provider, such as PayPal® or other online payment provider service, which may provide payments and other services on behalf of user. The second user may utilize the payment application to send a payment to the first user, where the first user may receive the payment, for example, in a payment account of the first user.

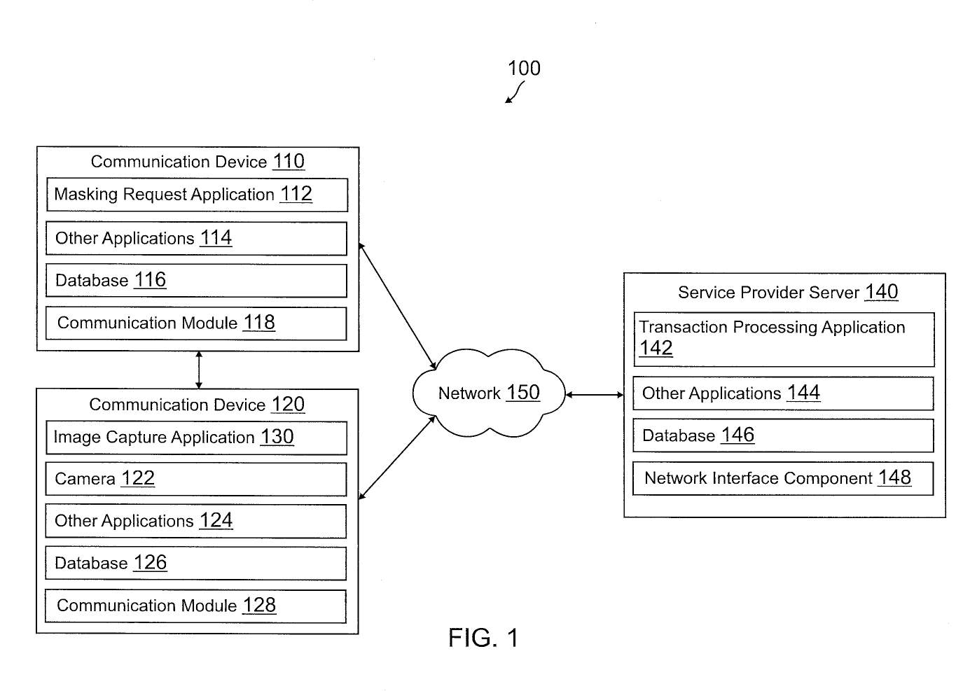

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user, a communication device 110, a communication device 120, and a service provider server 140 in communication over a network 150. A first user (not shown) may utilize communication device 110 to utilize the various features available for communication device 110, which may include processes and/or applications for image masking to mask a likeness of the first user in images captured by others. Thus, communication device 110 may establish a token including a data package used to cause image masking on another device. Communication device 110 may cause the token to be broadcast or otherwise receivable in an area or proximity around the first user by other devices, including communication device 120. Thus, when communication device 120 receives the token, communication device 120 may perform image masking. For example, a second user (not shown) may utilize communication device 120 to capture an image that may include the likeness of the first user. Communication device 120 may utilize the token to perform image masking by obscuring the likeness of the first user in the image based on the token. The second user may also request and/or pay to have the image masking removed from the image using communication device 120 to communicate with the first user through communication device 110. In various embodiments, service provider server 140 may be utilized to perform one or more of the aforementioned features, as well as payment processing for payments to remove image masking from images.

Communication device 110, communication device 120, and service provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Communication device 110 may be implemented as a communication device that may utilize appropriate hardware and software configured for wired and/or wireless communication with communication device 120 and/or service provider server 140. For example, in one embodiment, communication device 110 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Communication device 110 may include or be associated with a first user requesting masking of the first user's likeness in images captured by other users, such as a second user associated with communication device 120. Although only one communication device is shown, a plurality of communication devices may function similarly.

Communication device 110 of FIG. 1 contains a masking request application 112, other applications 114, a database 116, and a communication module 118. Masking request application 112 and other applications 114 may correspond to executable processes, procedures, and/or applications with associated hardware. In other embodiments, communication device 110 may include additional or different modules having specialized hardware and/or software as required.

Masking request application 112 may correspond to one or more processes to execute software modules and associated devices of communication device 110 to establish a token to cause image masking in an image that masks a likeness of a first user associated with communication device 110, as well as broadcast the token and receives requests for unmasking of the image. In this regard, masking request application 112 may correspond to specialized hardware and/or software utilized by a user of communication device 110 to first establish a request to mask the first user's likeness in images captured by other users, for example, based on preferences set by the first user and other user input from the first user. Thus, masking request application 112 may include one or more application interfaces, such as graphical user interfaces (GUIs), displayable by communication device 110 where the first user may enter one or more preferences or other user input related to image masking performed by masking request application 112. Although the term image is used, an image may instead correspond to different media in other contexts, including visual, audio, and audiovisual media. The preferences may include information related to when masking is required by the first user. For example, the first user may always require image masking of the first user's likeness in images captured by other devices. However, in other embodiments, the first user may only require image masking in a subset of circumstances, which may be time based, location based, user based (e.g., biometric, schedule, current event/interaction, etc.). The preferences for when to implement image masking on other devices may also be device or user/entity specific, such as on devices of particular users or entities, including work related devices, devices for venues or entertainment entities, or other specific circumstance requested by the first user. The first user may also request images only be masked in specific use contexts of the first image, such as transmission to other users, transmission to restricted users, uploaded to an image sharing and/or social networking service, or other use.

The first user may further establish preferences related to generation of the token and data included within the token. For example, the first user may provide a user image used during image processing to detect if the first user's likeness is captured in another image. The first user may provide other data, or masking request application 112 may determine the other data, for example, through image processing and facial/object recognition within a captured image. Additionally, the first user may select a masking image to utilize to obscure, conceal, or otherwise mask the first user's likeness in order to make the likeness indecipherable to other users. Masking request application 112 may provide one or more selectable images, such as known cartoons or other characters, emojis, icons, editing tools, or other image capable of masking the first user's likeness. Additionally, the first user may further load an image to masking request application 112 for use as the masking image.

The first user may further utilize masking request application 112 to establish information and preferences related to allowing another user that captures the likeness of the first user in an image to contact the first user to remove a masking image masking the likeness of the first user in the image. For example, the first user may allow other users that captured images where image masking was applied to mask the likeness of the first user to contact the first user to request authorization to remove the mask and/or receive an authorization (e.g., an executable code command) that removes the masking image from the images. In this regard, the first user may set an identifier with masking request application 112 that another user may use to contact the first user. The identifier may correspond to a phone number, location including current location of the first user (e.g., detectable through a GPS locator of communication device 110), a messenger name, email address, IP address for a device, or other identifier used to contact the first user. In various embodiments, the first user may be contactable directly through masking request application 112. Additionally the first user may establish a payment request, where a payment may be required to remove the masking image from images captured having the likeness of the first user. For example, the first user may require that other users provide a payment in order to unmask the first user and remove the masking image covering the likeness of the first user. The first user may set an amount for payment, terms of payment, as well as terms for using the unmasked image with masking request application 112.

Using the aforementioned information, masking request application 112 may generate a token used to cause masking of the first user's likeness in images captured by other users. Masking request application 112 may generate a file having executable code or larger data package, referred to herein as a token. The token may include at least a masking request to mask the likeness of the first user in images captured by others. In this regard, the masking request may correspond to executable code to cause another device to apply image masking in images having the likeness of the first user. In order to execute the masking request and apply image masking, the masking request and/or token may further include an image of the first user that includes the first user's likeness, or other data necessary to recognize the first user in images captured by others. Additionally, the token may include the masking image selected by the first user. However, where the masking image is not selected, masking request application 112 and/or the other device receiving the token may automatically determine or select the masking image. The token may be generated by masking request application 112. However, in other embodiments, a request to generate the token may be transmitted to service provider server 140 by masking request application 112, which may generate the token for transmission to other devices and/or communication device 110 for further use.

In various embodiments, masking request application 112 may broadcast the token, for example, over a proximity or area around communication device 110. The proximity and/or area to broadcast the token may be established based on a distance for short range wireless communications, a location of the first user, preferences set by the first user, and/or other factors that may determine whether another device may capture the first user's likeness in an image. Masking request application 112 may broadcast the token over short range wireless communications within the area or proximity. For example, masking request application 112 may utilize communication module 118 to transmit the token over one or more of near field communications (NFC), Bluetooth, Bluetooth Low Energy (BLE), WiFi (e.g., IEEE 802.11x standard), LTE Direct, radio, infrared, or other short range communication protocol. Masking request application 112 may use an “always on” type broadcast to continuously or intermittently transmit the token over the aforementioned communication protocol(s). In other embodiments, masking request application 112 may instead transmit an identifier for communication device 110 as described above, which may be used to pair communication device 110 with communication device 120. For example, communication device 120 may respond with an identifier for communication device 120, which may be utilized for data exchanges over a communication channel. Once the communication channel is established, masking request application 112 may transmit the token to communication device 120. In other embodiments, masking request application 112 may request that service provider server 104 perform the transmission of the token to devices within the area/proximity for the first user and/or communication device 110.

Masking request application 112 may be used to receive a request to remove a masking image applied to an image captured by a second user, such as the second user associated with communication device 120, where the masking image masks the first user's likeness in the image captured by the second user on communication device 120. The request may be a general request, where the first user may utilize masking request application 112 to deny the request, which may communicate a rejection to communication device 120, or approve the request. Where the request is approved, masking request application 112 and/or service provider server 140 may transmit an authorization to communication device 120, which may correspond to executable code that causes communication device 120 to remove the masking image from the image captured by the second user using communication device 120.

Additionally, the request may include the image with the first user, where the first user may view the image having the masking image and/or without the masking image using masking request application 112 to decide whether to reject and/or accept the request to remove the masking image. Additionally, the first user may use masking request application 112 to place terms of use on the unmasked image by the second user associated with communication device 120. The terms of use may limit the second user and/or communication device 120 for certain uses of the image and/or may reapply the masking image to the first user's likeness, for example, if the second user uses communication device 120 to transmit the image to another user or upload to a service. Where the second user pays for removal of the masking image, masking request application 112 and/or service provider server 140 may automatically communicate the authorization to communication device 120 for removal of the masking image from the image.

In various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 150, or other types of applications. Other applications 114 may also include email, texting, voice and IM applications that allow a user to send and receive emails, calls, texts, and other notifications through network 150. In various embodiments, other applications 114 may include financial applications, such as banking applications. Other applications 114 may also include other location detection applications, which may be used to determine a location for the user, such as a mapping, compass, and/or GPS application, which can include a specialized GPS receiver that obtains location information for communication device 110 and processes the location information to determine a location of communication device 110 and the user. Other applications 114 may include social networking applications, media viewing, and/or merchant applications. Other applications 114 may include device interfaces and other display modules that may receive input from the user and/or output information to the user. For example, other applications 114 may contain software programs, executable by a processor, including a graphical user interface (GUI) configured to provide an interface to the user. Other applications 114 may therefore use devices of communication device 110, such as display devices capable of displaying information to users and other output devices.

Communication device 110 may further include database 116 stored to a transitory and/or non-transitory memory of communication device 110, which may store various applications and data and be utilized during execution of various modules of communication device 110. Thus, database 116 may include, for example, identifiers such as operating system registry entries, cookies associated with masking request application 112 and/or other applications 114, identifiers associated with hardware of communication device 110, or other appropriate identifiers, such as identifiers used for payment/user/device authentication or identification, which may be communicated as identifying communication device 110 to service provider server 140. Database 116 may include a token used for image masking of the first user's likeness in images captured by others, as well as the preferences and other information used to generate the token. Moreover, unmasking requests and/or payment information to unmask an image may be stored to database 116.

Communication device 110 includes at least one communication module 118 adapted to communicate with communication device 120 and/or service provider server 140. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with nearby devices using short range communications, such as Bluetooth Low Energy, LTE Direct, WiFi, radio frequency, infrared, Bluetooth, and near field communications.

Communication device 120 may be implemented as a communication device that may utilize appropriate hardware and software configured for wired and/or wireless communication with communication device 110 and/or service provider server 140. For example, in one embodiment, communication device 120 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Communication device 120 may include or be associated with a second user capturing images including a likeness of the first user associated with communication device 120, where the images include a masking image masking the likeness of the first user based on a token received by communication device 120 from communication device 110. Although only one communication device is shown, a plurality of communication devices may function similarly.

Communication device 120 of FIG. 1 contains an image capture application 130, a camera 122, other applications 124, a database 126, and a communication module 128. Image capture application 130 and other applications 124 may correspond to processes, procedures, and/or applications executable by a hardware processor, for example, a software program. In other embodiments, communication device 120 may include additional or different modules having specialized hardware and/or software as required.

Image capture application 130 may correspond to one or more processes to execute modules and associated specialized hardware of communication device 120 that provides an application to capture images using a device camera of communication device 130, such as camera 122, where image capture application 130 may provide image masking of the image based on a token received from communication device 110. In this regard, image capture application 130 may correspond to specialized hardware and/or software of communication device 120 to capture images, where the images may correspond to still images, video images, or other digital media. Image capture application 130 may provide additionally processing after capturing an image, including cropping, adjusting color/saturation/resolution, or other editing procedures. Image capture application 130 may utilize functions associated with camera 122, such as flash, zoom, image resolution, or other camera parameter. Additionally, image capture application 130 may provide for creating, accessing, and editing a library of images, such as a photo book of captured images stored in database 114.

Camera 122 corresponds to an optical device of user device 110 enabling a second user associated with communication device 120 to record images, including still and/or video images. Camera 122 may correspond to a digital camera on communication device 120, or may more generally correspond to any device capable of recording an image or other digital media. Camera 122 may include various features, such as zoom, flash, focus correction, shutter speed controls, or other various features usable to capture one or more images of the first user, the second user, and/or other users. Camera 122 may further display a preview and/or captured image to the second user through another device of communication device 110, such as a viewfinder, screen (e.g., mobile phone screen), or other display.

The second user may utilize camera 122 with image capture application 130 to record a still image and/or video image containing a likeness of the first user associated with communication device 110. For example, the captured image may contain a portrait of the first user, such as a facial and/or full body portrait. Once captured, image capture application 130 may process the image with a token. For example, the token may include executable code that causes image capture application 130 to perform image analysis and processing, including facial and/or object recognition, which determines whether a likeness of the first user has been captured in the image. The likeness may further be detected by a user image or other data provided in the token used to identify the first user. If the likeness of the first user is detected in the image by image capture application 130, image capture application 130 may apply the masking image from the token (or generally applied if no masking image is provided). In various embodiments, prior to applying the masking image to mask the likeness of the first user in the image, image capture application 130 may utilize the likeness of the user in the image captured by communication device 120 and/or the user image/token provided by communication device 110 to determine whether the first user is known to the second user. For example, data corresponding to the likeness may be scanned across a contact list, stored/available images for the second user, a social networking or media sharing account of the second user, and/or other resource. In further embodiments, a likeness of the second user may similarly be scanned across resources of the first user. Thus, image capture application 130 may only mask the image where the first user and the second user are unknown to each other, or based on a degree of relationship between the users.

Additionally, image capture application 130 may provide an option to request removal of the masking image of the first user's likeness in the image. The option may be provided as a menu option within an application interface (e.g., a GUI) of image capture application 130. In other embodiments, the option may be provided through selection of the masking image in the image. Once selected, terms of the request may be displayed to the second user through the interface of image capture application 130. The terms may include any required payment, as well as identification of the second user, use of the image, reason for removal, or other required information requested by the first user for consideration of removal of the masking image. Once the adequate information is provided the request and/or payment may be provided to communication device 110 and/or service provider server 140 for processing.

In various embodiments, communication device 120 includes other applications 124 as may be desired in particular embodiments to provide features to communication device 120. For example, other applications 124 may include security applications for implementing client-side security features, programmatic client applications for interfacing with appropriate application programming interfaces (APIs) over network 150, or other types of applications. Other applications 124 may also include email, texting, voice and IM applications that allow a user to send and receive emails, calls, texts, and other notifications through network 150. In various embodiments, other applications 124 may include financial applications, such as banking applications. Other applications 124 may also include other location detection applications, which may be used to determine a location for the user, such as a mapping, compass, and/or GPS application, which can include a specialized GPS receiver that obtains location information for communication device 120 and processes the location information to determine a location of communication device 120 and the user. Other applications 124 may include social networking applications, media viewing, and/or merchant applications. Other applications 124 may include device interfaces and other display modules that may receive input from the user and/or output information to the user. For example, other applications 124 may contain software programs, executable by a processor, including a graphical user interface (GUI) configured to provide an interface to the user. Other applications 124 may therefore use devices of communication device 120, such as display devices capable of displaying information to users and other output devices.

Communication device 120 may further include database 126 stored to a transitory and/or non-transitory memory of communication device 120, which may store various applications and data and be utilized during execution of various modules of communication device 120. Thus, database 126 may include, for example, identifiers such as operating system registry entries, cookies associated with image capture application 130 and/or other applications 124, identifiers associated with hardware of communication device 120, or other appropriate identifiers, such as identifiers used for payment/user/device authentication or identification, which may be communicated as identifying communication device 120 to service provider server 140. Database 126 may further include images captured using camera 122, as well as tokens received from communication device 110 and/or other communication devices, which may be used to mask images stored to database 126.

Communication device 120 includes at least one communication module 128 adapted to communicate with communication device 110 and/or service provider server 140. In various embodiments, communication module 128 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 140 may be maintained, for example, by an online service provider, which may provide token generation and/or distribution (e.g., token transmission/broadcasting) services, as well as payment services, to one or more users. In this regard, service provider server 140 includes one or more processing applications which may be configured to interact with communication device 110, communication device 120, and/or another device/server to facilitate connecting users having a shared interest. In one example, service provider server 140 may be provided by PAYPAL®, Inc. of San Jose, Calif., USA. However, in other embodiments, service provider server 140 may be maintained by or include another type of service provider, which may provide the aforementioned services to a plurality of users.

Service provider server 140 of FIG. 1 includes a transaction processing application 142, other applications 144, a database 146, and a network interface component 148. Transaction processing application 142 and other applications 144 may correspond to executable processes, procedures, and/or applications with associated hardware. In other embodiments, service provider server 140 may include additional or different modules having specialized hardware and/or software as required.

Transaction processing application 142 may correspond to one or more processes to execute software modules and associated specialized hardware of service provider server 140 to provide payment services to users, for example though a payment account and/or payment instruments, which may include payment to remove a masking image that masks a likeness of a first user associated with communication device 110 in an image captured by a second user using communication device 120. In this regard, transaction processing application 142 may correspond to specialized hardware and/or software to provide payment services and payment accounts, including digital wallets storing payment instruments. The payment services may allow for a payment to the first user by the second user through a payment instrument, including a credit/debit card, banking account, payment account with service provider server 140, and/or other financial instrument. In order to establish a payment account for a user to send and receive payments, transaction processing application 142 may receive information requesting establishment of the payment account. The information may include user personal and/or financial information. Additionally the information may include a login, account name, password, PIN, or other account creation information. The user may provide a name, address, social security number, or other personal information necessary to establish the account and/or effectuate payments through the account. Transaction processing application 142 may further allow the user to service and maintain the payment account, for example, by adding and removing payment instruments. Transaction processing application 142 may be used to provide a payment to remove a masking image from an image captured by the second user using communication device 120, for example, using the account and/or digital wallet of the second user to provide a payment to an account of the first user associated with communication device 110. Transaction processing application 142 may debit an account of the second user automatically and provide the payment to an account of the first user. Transaction processing application 142 may also be used to provide transaction histories for processed transactions. Once payment is provided to the first user, transaction processing application 142 may further be utilized to provide an authorization or other command to communication device 120, where the command causes removal of the masking image masking the likeness of the first user in the image captured by the second user on communication device 120. In various embodiments, the first user may be required to approve the transaction and/or payment to remove the masking image. Additionally, the first and/or second user may be required to provide and/or agree to terms of use of the image after removal of the masking image, where transaction processing application 142 may further monitor the usage of the image.

In various embodiments, service provider server 140 includes other applications 144 as may be desired in particular embodiments to provide features to service provider server 140. For example, other applications 144 may include security applications for implementing server-side security features, programmatic client applications for interfacing with appropriate application programming interfaces (APIs) over network 150, or other types of applications. Additionally, other application 142 may include one or more applications, which may provide the features and/or service described in reference to masking request application 112 of communication device 110, such as generation of a token for image masking and/or transmission of the token to one or more communication devices, including communication device 120. Other applications 144 may contain software programs, executable by a processor, including a graphical user interface (GUI), configured to provide an interface to the user when accessing service provider server 140, where the user or other users may interact with the GUI to more easily view and communicate information. In various embodiments, other applications 144 may include connection and/or communication applications, which may be utilized to communicate information to over network 150.

Additionally, service provider server 140 includes database 146. As previously discussed, a user may establish one or more digital wallets and/or payment accounts with service provider server 140. Digital wallets and/or payment accounts in database 146 may include user information, such as name, address, birth date, payment instruments/funding sources, additional user financial information, user preferences, and/or other desired user data. Users may link to their respective digital wallets and/or payment accounts through an account, user, and/or device identifier. Thus, when an identifier is transmitted to service provider server 140, e.g., from communication device 110, one or more digital wallets and/or payment accounts belonging to the users may be found. Database 146 may also store tokens used for image masking, as well as image data for masked images and transaction information to remove a masking image from one or more of the masked images.

In various embodiments, service provider server 140 includes at least one network interface component 148 adapted to communicate communication device 110 and/or communication device 120 over network 150. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

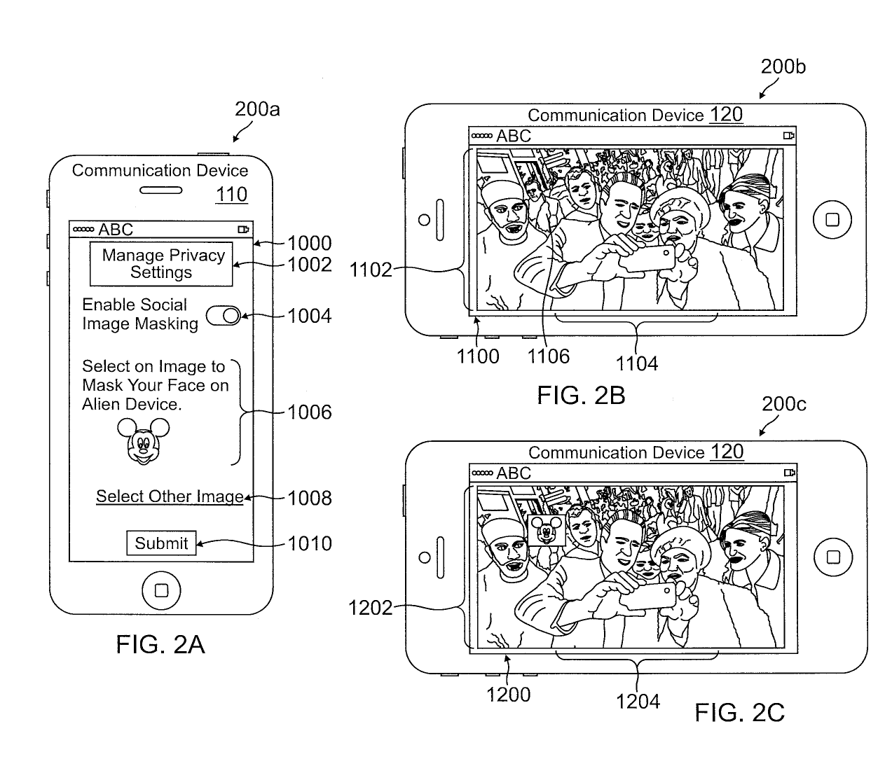

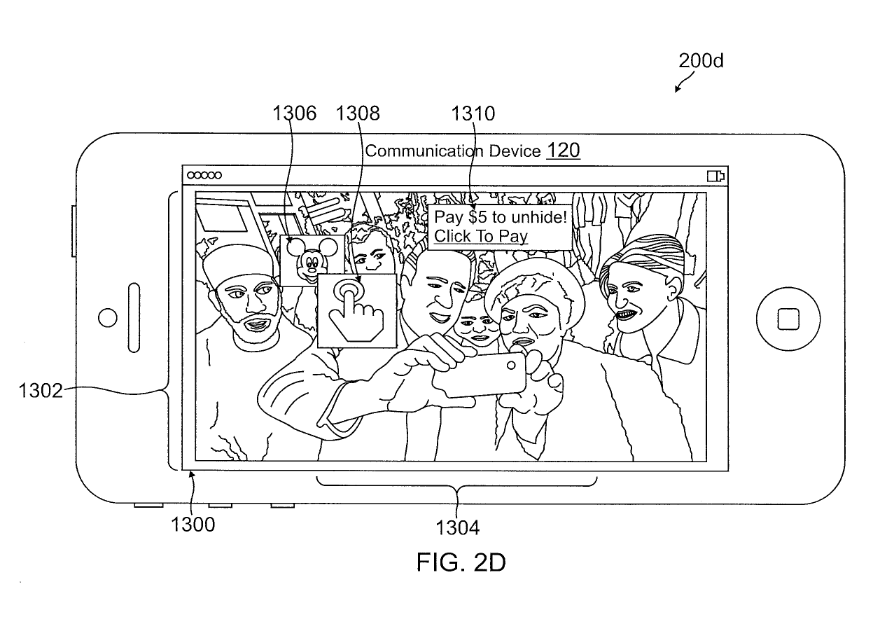

FIG. 2A is an exemplary setup screen for facial privacy through masking of a first user's likeness captured in images of others, according to an embodiment. Environment 200a includes a communication device 110 corresponding generally to the described features, processes, and components of communication device 110 in environment 100 of FIG. 1. In this regard, a first user utilizing communication device 110 may view an interface 1000 on communication device 110, where interface 1000 provides features for establishment of a token used to mask a likeness of the first user in images captured by other users, such as masking request application 112 of communication device 110 in environment 100 of FIG. 1.

In this regard, interface 1000 includes a privacy settings menu 1002, where a first user may establish one or more preferences regarding image masking of the first user's likeness in images captured by other users. For example the first user may select and enable social image masking option 1004, where selection of the enable social image masking option 1004 establishes that the first user chooses to have their likeness masked in images captured by other users. Additionally, the first user may select a masking image 1006 for use in masking the first user's likeness in the other images. Masking image 1006 may be selected from available images selectable through interface 1000 or may be loaded to interface 1000 by the first user. For example, the first user may select an option 1008 to choose a separate masking image for masking of the user's likeness. Once the first user is satisfied with their selections, the first user may select a submit 1010 option to establish a token used for image masking in an image captured by communication device 120 in environment 200b of FIG. 2B.

FIG. 2B is an exemplary image captured by a second user's communication device and including the likeness of the first user, according to an embodiment. Environment 200b includes a communication device 120 corresponding generally to the described features, processes, and components of communication device 120 in environment 100 of FIG. 1. In this regard, a second user utilizing communication device 120 may view an interface 1100 on communication device 120, where interface 1100 corresponds to an interface of an image capture application, such as image capture application 130 of communication device 120 in environment 100 of FIG. 1.

In this regard, a second user may utilize communication device 120 to capture an image, where the image may include the likeness of the first user utilizing communication device 110. For example, interface 1100 includes an interface of an image capture application associated with a camera, where the camera has captured image 1102. Image 1102 includes a subject 1104 of the image, for example, an image of two users' likenesses while they are being photographed. However, image 1002 further includes a likeness of the first user 1106 in the background, where the first user wishes that the likeness of the first user 1106 be masked or otherwise hidden in image 1102.

FIG. 2C is an exemplary image captured by a second user's communication device with the likeness of the first user hidden by a masking image, according to an embodiment. Environment 200c includes a communication device 120 corresponding generally to the described features, processes, and components of communication device 120 in environment 100 of FIG. 1. In this regard, a second user utilizing communication device 120 may view an interface 1200 on communication device 120, where interface 1200 corresponds to an interface of an image capture application having a masked image, such as image capture application 130 of communication device 120 in environment 100 of FIG. 1.

In this regard, interface 1200 in environment 200c displays an image 1202 after image masking is applied based on a received token. For example, after the second user captures image 1102 of FIG. 2B, communication device 120 may apply image masking based on a token received by communication device 120 requiring image masking of a likeness of a first user in image 1102. Thus, image 1202 display image 1102 from FIG. 2B after image masking. In this regard, a subject 1204 is still shown in the image. However, a likeness of the first user 1106 from image 1102 of FIG. 2B is instead shown with a masking image 1206 covering the likeness of the first user 1106. Thus, the first user is masked in image 1202.

FIG. 2D is an exemplary image captured by a second user's communication device and providing a payment option to remove the masking image hiding the likeness of the first user, according to an embodiment. Environment 200d includes a communication device 120 corresponding generally to the described features, processes, and components of communication device 120 in environment 100 of FIG. 1. In this regard, a second user utilizing communication device 120 may view an interface 1300 on communication device 120, where interface 1300 corresponds to an interface of image capture applications providing a payment option to remove image masking, such as image capture application 130 of communication device 120 in environment 100 of FIG. 1.

In this regard, interface 1300 display an image 1302 after image masking is applied to the image to mask a likeness of a first user in image 1302 based on a token received by communication device 120. However, a second user viewing interface 1300 having image 1302 may further be provided with an option 1308 to contact the first user and/or pay the first user for removal of masking image 1306 that masks the first user's likeness in image 1302. For example, a subject 1304 may still be shown in image 1302, however, the second user may wish to remove masking image 1306 from image 1302. By selecting option 1308, the second user may be shown terms 1310 for removal of masking image 1306. If the second user agrees to the terms 1310, for example, by selecting a link and completing a payment to the first user, masking image 1306 may be removed from image 1302.

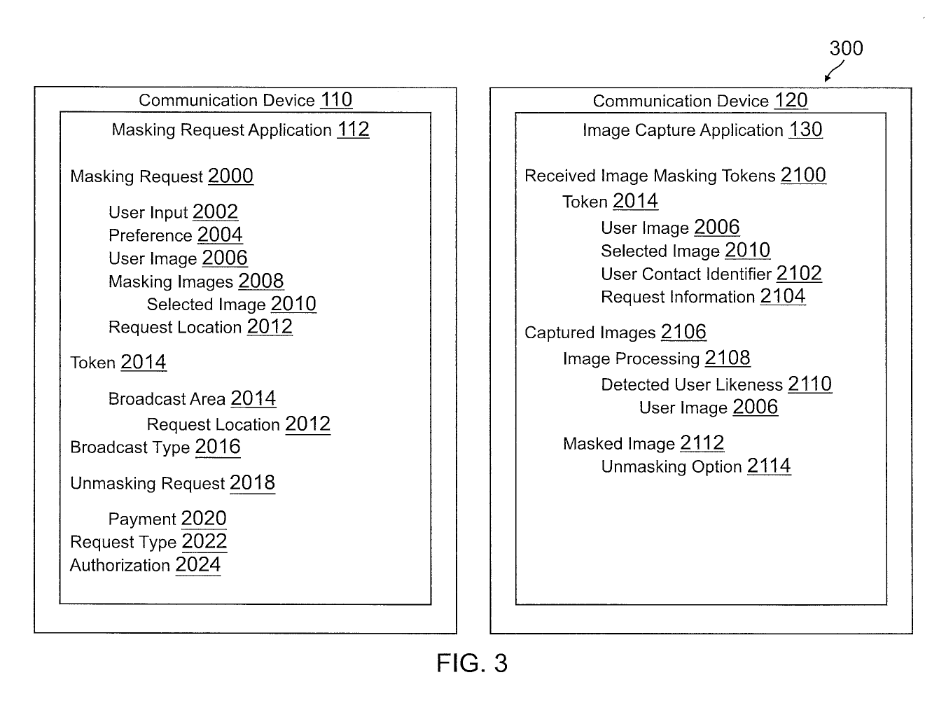

FIG. 3 is an exemplary system environment showing two communication devices interacting for use of a locally broadcasted token to cause image masking of user likeness, according to an embodiment. FIG. 3 includes communication device 110 and communication device 130 all discussed in reference to environment 100 of FIG. 1.

Communication device 110 executes masking request application 112 corresponding generally to the specialized hardware and/or software modules and processes described in reference to FIG. 1. In this regard, masking request application 112 may be utilized to generate a token used for image masking of a likeness of a first user associated with communication device 110 in images captured by communication device 120. Thus, masking request application 112 includes a masking request 2000 by the first user and including information and preferences set by the first user for image masking of the first user's likeness in images captured by others. For example, masking request 2000 includes user input 2002 by the first user, such as a request to generate a token for image masking, as well as an identifier for the first user used to contact the first user. Additionally, masking request 2000 further includes preferences 2004 set by the first user and a user image 2006 selected by the first user and used for facial/object recognition of the first user's likeness in the images captured by others. The first user may further view masking images 2008 in masking request application 112, which includes a selected image 2010 by the first user and used as the masking image. Additionally, the first user may set a request location 2012 for image masking, which may correspond to a current location of the first user.

Using the aforementioned information, masking request application 112 may cause a token 2014 to be generated, for example, through one or more processes of masking request application 112 and/or a service provider. Token 2014 may further be associated with a broadcast area 2014, such as request location 2012. Additionally, token 2014 may be associated with a broadcast type 2016, such as a communication channel and/or protocol used to communication token 2014 to another device. Masking request application 112 may further receive an unmasking request 2018 from communication device 120. Unmasking request 2018 may include a payment 2020 from the second user associated with communication device 120, as well as a request type 2022, which may be responded to with an authorization 2024.

Communication device 120 executes image capture application 130 corresponding generally to the specialized hardware and/or software modules and processes described in reference to FIG. 1. In this regard, image capture application 130 may be used to capture images, including an image having a likeness of the first user associated with communication device 110. Thus, image capture application 130 may mask the first user's likeness based on received image masking tokens 2100. For example, received image masking tokens 2100 includes token 2014 having user image 2006 and selected image 2010 used for determination of whether an image includes a likeness of the first user and masking the likeness in images, respectively. Additionally, token 2014 may further include a user contact identifier 2012 for communication device 110 and/or the first user, as well as request information 2104, which may include additional information used for masking and/or unmasking of the first user's likeness in an image. Thus, image capture application 130 may utilize token 2014 with captured images 2106. For example, image processing 2108 may be applied to captured images 2106 to determine detected user likeness 2110, for example, through user image 2006 in token 2014. Thus, captured images 2106 may include masked image 2112 based on image processing 2108, which may be associated with an unmasking option 2114 to remove image masking in masked image 2112.

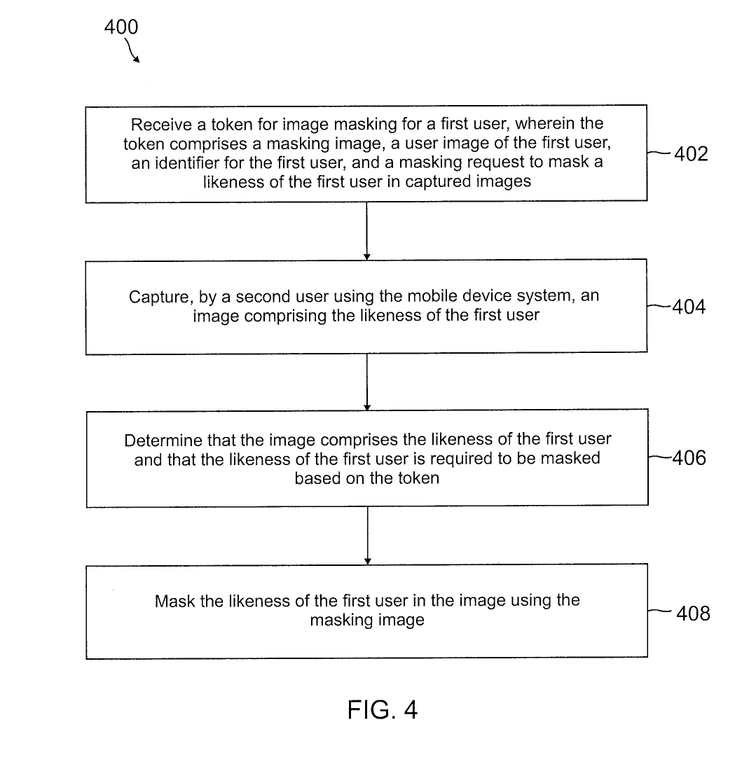

FIG. 4 is a flowchart of an exemplary process for a locally broadcasted token to cause image masking of user likeness, according to an embodiment. Note that one or more steps, processes, and methods described herein may be omitted, performed in a different sequence, or combined as desired or appropriate.

At step 402, a token for image masking for a first user is received, wherein the token comprises a masking image, a user image of the first user, an identifier for the first user, and a masking request to mask a likeness of the first user in captured images. The identifier may not always be required where the first user does not wish to be contacted by a second user capturing an image having the likeness of the first user. The identifier may comprise one of a phone number, a messaging name, a location, and a personal name. The token may correspond to a data package comprising the masking image, the user image, the identifier, and the masking request. Thus, the token may be broadcasted within a proximity to a geo-location of the first user. For example, a device for the first user may broadcast the token within the proximity using short range wireless communications.

The token may be received from one of a service provider server over a network connection based on a first location of the first user and a second location of the second user, a location specific device at the second location of the second user, and a device of the first user over short range wireless communications between the device of the first user and the mobile device system of the second user. Thus, the first user may set preferences for image masking with one of the device and the service provider server, and wherein the token is transmitted to the mobile device system based on the preferences. The preferences may include a selection of the masking image, wherein the selection is from a group of available characters images.

At step 404, a second user using the mobile device system captures an image comprising a likeness of the first user. It is determined that the image comprises the likeness of the first user and that the likeness of the first user is required to be masked based on the token, at step 406. In various embodiments, it may also be determined that the image is required to be masked based on a contact list of the second user, for example, where the contact list for the second user comprises one of an address book for the second user, a social networking account of the second user, and/or an electronic messaging account of the second user. It may be determined that the image comprises the likeness using at least one of image processing of the image by the mobile device system and facial recognition of the first user in the image using the user image of the first user.

At step 408, the likeness of the first user in the image is masked using the masking image. Additionally, a contact option may be provided to the second user for unmasking of the likeness of the first user in the image, wherein the contact option utilizes the identifier to contact the first user. The contact option may further comprise a purchase offer to unmake the likeness of the first user, and wherein the token comprises an amount for the purchase offer

Additionally, the token may further comprises a payment option to unmask the likeness of the first user in the image. Thus, a payment request may be received for the payment option at the second user's device, wherein the payment request comprises a request to unmask the likeness of the first user in the image and a payment instrument for payment of the payment option. The payment request may be communicated to one of a device for the first user and a service provider for payment processing. In response to communicating the payment request, an authorization to unmask the likeliness of the first user in the image may be received, and the masking image may be removed from the image based on the authorization.

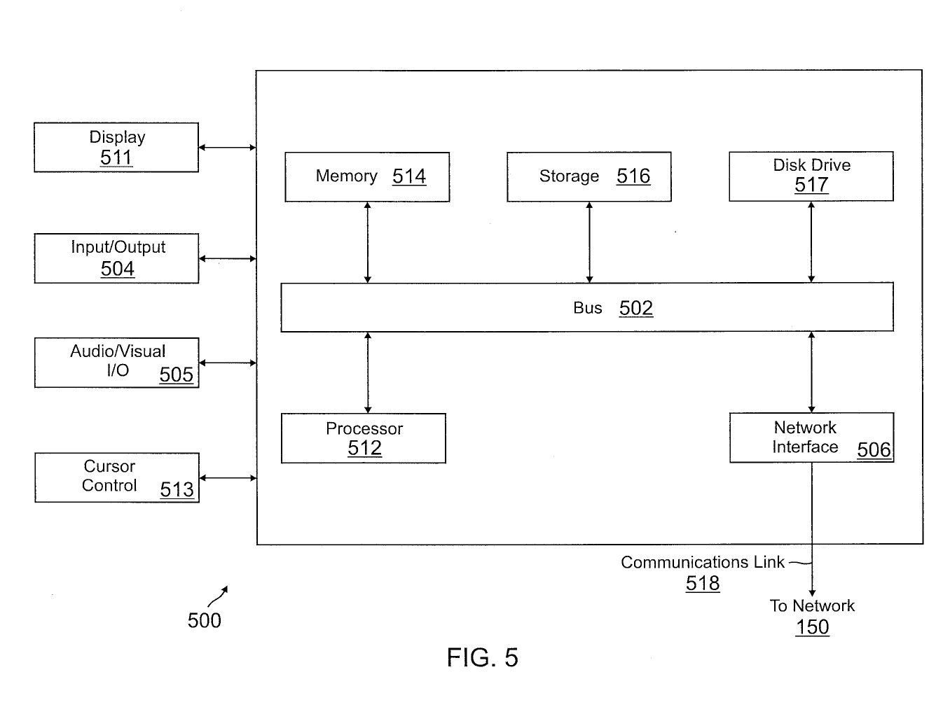

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A mobile device system comprising:
a non-transitory memory; and
one or more hardware processors coupled to the non-transitory memory and configured to read instructions from the non-transitory memory to cause the system to perform operations comprising:
receiving a token for image masking for a first user, wherein the token comprises a masking image, a user image of the first user, an identifier for the first user, and a masking request to mask a likeness of the first user in captured images;
capturing, by a second user using the mobile device system, an image comprising the likeness of the first user;
determining that the image comprises the likeness of the first user;
determining that the likeness of the first user is required to be masked based on the token and a contact list for the second user; and
masking the likeness of the first user in the image using the masking image.

2. The mobile device system of claim 1, wherein the contact list for the second user comprises one of an address book for the second user, a social networking account of the second user, or an electronic messaging account of the second user.

3. The mobile device system of claim 1, wherein the operations further comprise:
providing a contact option to the second user for unmasking of the likeness of the first user in the image using the masking image, wherein the contact option utilizes the identifier to contact the first user.

4. The mobile device system of claim 3, wherein the contact option further comprises a purchase offer to unmask the likeness of the first user, and wherein the token comprises an amount for the purchase offer.

5. The mobile device system of claim 1, wherein the token is received from one of a service provider server over a network connection based on a first location of the first user and a second location of the second user, a location specific device at the second location of the second user, or a device of the first user over short range wireless communications between the device of the first user and the mobile device system of the second user.

6. The mobile device system of claim 5, wherein the first user sets preferences for image masking with one of the device and the service provider server, and wherein the token is transmitted to the mobile device system based on the preferences.

7. The mobile device system of claim 6, wherein the preferences include a selection of the masking image, and wherein the selection is from a group of available characters images.

8. The mobile device system of claim 1, wherein the determining that the image comprises the likeness uses at least one of image processing of the image by the mobile device system and facial recognition of the first user in the image using the user image of the first user.

9. The mobile device system of claim 1, wherein the token corresponds to a data package comprising the masking image, the user image, the identifier, and the masking request.

10. The mobile device system of claim 1, wherein the token is broadcasted within a first distance to a geo-location of the first user.

11. The mobile device system of claim 10, wherein a device for the first user broadcasts the token within the first distance using short range wireless communications.

12. A method comprising:
receiving, by a mobile device that comprises one or more hardware processors coupled to a non-transitory memory, a token for image masking for a first user, wherein the token comprises a masking image, a user image of the first user, and a masking request to conceal a likeness of the first user in captured images;
capturing, by a second user using the mobile device, an image comprising the likeness of the first user;
determining that the image comprises the likeness of the first user;
determining that the likeness of the first user is required to be masked based on the token; and
masking the likeness of the first user in the image using the masking image.

13. The method of claim 12, wherein the token further comprises an identifier for the first user, and wherein the identifier is used to contact to first user by the second user.

14. The method of claim 13, wherein the identifier comprises one of a phone number, a messaging name, a location, and a personal name.

15. The method of claim 12, further comprising
determining that the likeness of the first user is required to be masked further comprises determining that the first user is not found in a contact list for the second user.

16. The method of claim 12, wherein the token further comprises a payment option to unmask the likeness of the first user in the image, and wherein the method further comprises:
receiving a payment request for the payment option, wherein the payment request comprises a request to unmask the likeness of the first user in the image and a payment instrument for payment of the payment option;
communicating the payment request to one of a device for the first user and a service provider for payment processing;
receiving an authorization to unmask the likeliness of the first user in the image; and
removing the masking image from the image based on the authorization.

17. A system comprising:
a non-transitory memory; and
one or more hardware processors coupled to the non-transitory memory and configured to read instructions from the non-transitory memory to cause the system to perform operations comprising:
establishing a token for image masking of a first user, wherein the token comprises a masking image, a user image of the first user, and a masking request to conceal a likeness of the first user in captured images;
receiving a request from the first user to broadcast the token over a proximity to the first user; and
broadcasting the token over the proximity to the first user, wherein the token is communicated to at least one other device.

18. The system of claim 17, wherein the establishing the token comprises one of generating the token using an image masking application executing on by the system of the first user and requesting the token to be generated by a service provider offering image masking services, wherein the service provider communicates the token to the system for storage by the non-transitory memory.

19. The system of claim 17, wherein the token further comprises a payment option for payment by a second user to the first user to unmask the likeness of the first user in an image captured by a second user.

20. The system of claim 19, wherein the operations further comprise:
receiving information for the payment by the second user to the first user to unmask the likeness of the first user in the image captured by the second user; and
providing an authorization to a requesting device of the second user, wherein the authorization comprises a command to remove the masking image on the image.
